(19) United States
(12) Patent Application Publication
(10) Pub. No.: US 2009/0004510 A1
(43) Pub. Date: Jan. 1, 2009

(54) Substrate For Perpendicular Magnetic Recording Medium, Method Of Manufacturing The Same, And Perpendicular Magnetic Recording Medium

(75) Inventor: Masahiro Ohmori, Tochigi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SHOWA DENKO K.K., Minato-ku, Tokyo (JP)

(21) Appl. No.: 11/574,250

(22) PCT Filed: Aug. 25, 2005
(86) PCT No.: PCT/JP2005/015967

§ 371 Date: Feb. 26, 2007

Related U.S. Application Data
(60) Provisional application No. 60/606,147, filed on Sep. 1, 2004.

(30) Foreign Application Priority Data
Aug. 26, 2004 (JP) 2004-246818

(51) Int. Cl. G11B 5/667; B05D 5/12; B05D 1/36; B05D 3/12; G11B 5/738; G11B 5/84; G11B 5/858

(52) U.S. Cl. 428/814; 428/834; 428/828; 427/127; 427/131; 427/129; 427/130

(57) ABSTRACT

A substrate for perpendicular magnetic recording medium 2 is provided with a soft magnetic substrate coat 5. On this soft magnetic substrate coat 5, an anticorrosion coat 5 is formed. The anticorrosion coat 6 is preferably formed so as to completely cover the entire soft magnetic substrate coat 5.

### CROSS REFERENCE TO RELATED APPLICATIONS

This application claims priority to Japanese Patent Application No. 2004-246818 filed on Aug. 26, 2004 and U.S. Provisional Application Ser. No. 60/606,147 filed on Sep. 1, 2004, the entire disclosures of which are incorporated herein by reference in their entireties.

This application is an application filed under 35 U.S.C.§111(a) claiming the benefit pursuant to 35 U.S.C.§119(e)(1) of the filing date of U.S. Provisional Application Ser. No. 60/606,147 filed on Sep. 1, 2004, pursuant to 35 U.S.C.§111(b).

### TECHNICAL FIELD

The present invention relates to a substrate for a perpendicular magnetic recording medium, a method for manufacturing the substrate, and a perpendicular magnetic recording medium. More specifically, the preferred embodiments relate to a substrate for a perpendicular magnetic recording medium provided with a recording coat including a magnetic coat in which an easy axis of magnetization is oriented perpendicular to a substrate, its manufacturing method, a perpendicular magnetic recording medium and a perpendicular magnetic recording reproducing apparatus equipped with the substrate.

### BACKGROUND ART

The following description sets forth the inventor's knowledge of related art and problems therein and should not be construed as an admission of knowledge in the prior art.

One of magnetic recording systems is a longitudinal magnetic recording system utilizing a magnetic coat having an easy axis of magnetization oriented parallel to the substrate surface. In this system, however, as the recording density increases, the recording range decreases, resulting in a decreased volume of the magnetic particles, which in turn causes an unignorable demagnetization effect due to thermal agitation. Thus, the thermal stability deteriorates. This adverse effect will be exposed as the density growth advances.

As a method for eliminating the adverse effect caused by the growth of high-density recording, in recent years, a perpendicular magnetic recording system utilizing a magnetic coat in which an easy axis of magnetization of magnetic substances of a magnetic recording coat is oriented perpendicular to the substrate surface has been proposed.

In order to write signals in a magnetic recording coat, it is required to attain saturation magnetization of magnetic particles in magnetic domains of a magnetic recording coat by magnetic leaking from a magnetic head. In the longitudinal magnetic recording system, however, it is known to decrease the magnetic recording coat as thin as possible to attain the complete saturation magnetization.

To the contrary, in a perpendicular magnetic recording system, the method uses a super position type medium in which a soft magnetic substrate coat having high saturation magnetic flux density is provided under a perpendicular magnetic recording coat and a single magnetic pole. Therefore, the soft magnetic substrate coat undertakes a role to strongly draw the magnetic field leaked from the magnetic head and return to the magnetic head, which makes it easy to attain the saturation magnetization of the magnetic recording coat without decreasing the thickness of the magnetic recording coat.

Although it is preferable that the aforementioned soft magnetic substrate coat is high in magnetic permeability and high in saturation magnetic flux density, components (elements) for giving soft magnetic characteristic to the soft magnetic substrate coat are generally limited. For example, cobalt or iron is conventionally used as a main composition element of the soft magnetic substrate coat to give soft magnetic characteristic to a soft magnetic substrate coat, and further several additive elements are also used to improve the soft magnetic characteristic (see, e.g., Japanese Unexamined Laid-open Patent Publication No. H11-149628, Japanese Unexamined Laid-open Patent Publication No. 2003-077123).

Furthermore, for the purpose of decreasing noise to be generated at the time of recording or reproducing information, conventionally known is a perpendicular magnetic recording medium with a two-layered soft magnetic substrate coat wherein the upper layer is a granular structure layer (see, e.g., Japanese Unexamined Laid-open Patent Publication No. 2002-092843). Furthermore, for the purpose of controlling crystal orientation, also conventionally know is a perpendicular magnetic recording medium with a two-layered soft magnetic substrate coat wherein the upper layer is crystalline soft magnetic layer (see, e.g., Japanese Unexamined Laid-open Patent Publication No. 2002-208129).

It should be noted that a soft magnetic substrate coat according to the present invention does not denote a general substrate coat of a magnetic coat, but denotes a backing coat (layer) in a perpendicular magnetic recording medium.

Corrosion resistance is very important characteristic for a perpendicular magnetic recording medium. However, in a conventional perpendicular magnetic recording medium, a soft magnetic substrate coat was generally poor in corrosion resistance and therefore corrosion-prone.

Under the circumstance, in a conventional perpendicular magnetic recording medium, corrosion resistance of a soft magnetic substrate coat was secured by a protective coat formed on a perpendicular magnetic coat (perpendicular magnetic recording coat). However, since the main purpose of the protective coat was to prevent damage of the perpendicular magnetic coat caused by contact between the magnetic head and the perpendicular magnetic coat, the protective coat was not enough to secure the corrosion resistance of the soft magnetic substrate coat. Furthermore, since this protective coat was formed as thin as possible so as to decrease the distance between the magnetic head and the perpendicular magnetic coat, it was difficult to secure corrosion resistance of the soft magnetic substrate coat by the protective coat.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### DISCLOSURE OF INVENTION

The preferred embodiments of the present invention have been developed in view of the above-mentioned and/or other problems in the related art. The preferred embodiments of the present invention can significantly improve upon existing methods and/or apparatuses.

The present invention was made in view of the aforementioned technical back ground, and aims to provide a perpendicular magnetic recording medium substrate having a soft magnetic substrate coat high in corrosion resistance, its manufacturing method, a perpendicular magnetic recording medium using the substrate, and a perpendicular magnetic recording reproducing apparatus equipped with the perpendicular magnetic recording medium.

The inventor's eager study revealed that, in a perpendicular magnetic recording medium substrate having a soft magnetic substrate coat, a perpendicular magnetic recording medium substrate with high corrosion resistance can be obtained by forming an anticorrosive coat for preventing corrosion of the soft magnetic substrate coat. Based on the knowledge, the present invention was completed. The present invention provides the following means.

[1] A substrate for a perpendicular magnetic recording medium, the substrate comprising:
a soft magnetic substrate coat; and
an anticorrosion coat for preventing corrosion of the soft magnetic substrate coat, wherein the anticorrosion coat is formed on the soft magnetic substrate coat.

[2] The substrate for a perpendicular magnetic recording medium as recited in the aforementioned Item 1, wherein the anticorrosion coat is formed so as to completely cover the entire soft magnetic substrate coat.

[3] The substrate for a perpendicular magnetic recording medium as recited in the aforementioned Item 1 or 2, wherein the anticorrosion coat is made of metallic material.

[4] The substrate for a perpendicular magnetic recording medium as recited in any one of the aforementioned Items 1 to 3, wherein the anticorrosion coat contains nickel and at least one element selected from the group consisting of phosphorus and boron.

[5] The substrate for a perpendicular magnetic recording medium as recited in the aforementioned Item 4, wherein the anticorrosion coat further contains at least one element selected from the group consisting of gold, tungsten and molybdenum.

[6] The substrate for a perpendicular magnetic recording medium as recited in any one of the aforementioned Items 1 to 5, wherein the anticorrosion coat is formed by an electroless plating method.

[7] The substrate for a perpendicular magnetic recording medium as recited in any one of the aforementioned Items 1 to 6, wherein an average particle diameter of the anticorrosion coat is 20 nm or less, or particles of the anticorrosion coat is in the form of amorphous.

[8] The substrate for a perpendicular magnetic recording medium as recited in any one of the aforementioned Items 1 to 7, wherein a thickness of the anticorrosion coat is 1 nm to 5,000 nm.

[9] The substrate for a perpendicular magnetic recording medium as recited in any one of the aforementioned Items 1 to 8, wherein an average surface roughness Ra of a surface of the anticorrosion coat is 2.0 nm or less.

[10] A method for manufacturing a perpendicular magnetic recording medium substrate having a soft magnetic substrate coat, the method comprising the steps of:
forming an anticorrosion coat for preventing corrosion of the soft magnetic substrate coat on the soft magnetic substrate coat by an electroless plating method.

[11] The method for manufacturing a perpendicular magnetic recording medium substrate as recited in the aforementioned Item 10, further comprising the step of:
forming a metal core or a seed coat on a substrate main body; and
forming the soft magnetic substrate coat on the metal core or the seed coat by an electroless plating method.

[12] The method for manufacturing a perpendicular magnetic recording medium substrate as recited in the aforementioned Item 10 or 11, wherein the anticorrosion coat is formed by the electroless plating method subsequently after forming the soft magnetic substrate coat.

[13] The method for manufacturing a perpendicular magnetic recording medium substrate as recited in any one of the aforementioned Items 10 to 12, wherein a surface of the substrate is polished before or after forming the anticorrosion coat.

[14] The method for manufacturing a perpendicular magnetic recording medium substrate as recited in the aforementioned Item 13, wherein the substrate is heat treated at a temperature falling within the range of 100 to 350° C. before polishing the surface of the substrate.

[15] A perpendicular magnetic recording medium substrate manufactured by the method for manufacturing a perpendicular magnetic recording medium substrate as recited in any one of the aforementioned Items 10 to 14.

[16] A perpendicular magnetic recording medium, comprising:
a perpendicular magnetic recording medium substrate as recited in any one of the aforementioned Items 1 to 9, or 15;
an orientation controlling coat for controlling an orientation of a coat immediately arranged above;
a perpendicular magnetic coat in which an easy axis of magnetization is oriented mainly perpendicular to the substrate; and
a protective coat.

[17] A perpendicular magnetic recording reproducing apparatus, comprising:
a perpendicular magnetic recording medium as recited in the aforementioned Item 15; and
a magnetic head for recording and reproducing information in and from the perpendicular magnetic recording medium.

According to the present invention, it is possible to provide a high corrosion resistance substrate for a perpendicular magnetic recording medium and its manufacturing method.

Furthermore, according to the present invention, it is possible to provide a perpendicular magnetic recording medium capable of holding information recorded in a perpendicular magnetic coat in a good condition by forming an orientation controlling coat, a perpendicular magnetic coat and a protective coat on the substrate.

The effects of the present invention will be detailed.

According to the invention as recited in the aforementioned Item [1], a high corrosion resistance substrate for a perpendicular magnetic recording medium can be provided.

According to the invention as recited in the aforementioned Item [2], it is possible to prevent corrosion of the soft magnetic substrate coat advancing from the side surfaces of the substrate.

According to the invention as recited in the aforementioned Item [3], the corrosion resistance performance of the anticorrosion coat can be improved.

According to the invention as recited in the aforementioned Item [4], the corrosion resistance performance of the anticorrosion coat can be further improved.

According to the invention as recited in the aforementioned Item [5], the corrosion resistance performance of the anticorrosion coat can be still further improved.

According to the invention as recited in the aforementioned Item [6], it is possible to assuredly and easily form the anticorrosion coat so as to completely cover the entire soft magnetic substrate coat.

According to the invention as recited in the aforementioned Item [7], the corrosion resistance performance of the anticorrosion coat can be further improved.

According to the invention as recited in the aforementioned Item [8], the corrosion resistance performance of the anticorrosion coat can be secured assuredly.

According to the invention as recited in the aforementioned Item [9], a coat (e.g., an orientation controlling coat or a perpendicular magnetic coat) to be formed on the anticorrosion coat can be formed in a preferable manner.

According to the invention as recited in the aforementioned Item [10] to [14], the substrate for a perpendicular magnetic recording medium according to the present invention can be formed assuredly.

According to the invention as recited in the aforementioned Item [15], a high corrosion resistance substrate for a perpendicular magnetic recording medium can be provided.

According to the invention as recited in the aforementioned Item [16], it is possible to provide a perpendicular magnetic recording medium capable of holding information recorded in a perpendicular magnetic coat in a good condition for a long time period.

According to the invention as recited in the aforementioned Item [17], it is possible to provide a perpendicular magnetic recording reproducing apparatus capable of recording and reproducing information in and from the perpendicular magnetic recording medium.

### BRIEF DESCRIPTION OF DRAWINGS

The preferred embodiments of the present invention are shown by way of example, and not limitation, in the accompanying figures, in which:

FIG. 1 is a cross-sectional view showing a perpendicular magnetic recording medium according to an embodiment of this invention is employed;

FIG. 2 is a graph showing an example of an MH curve;

FIG. 3 is a graph showing another example of an MH curve;

FIG. 4A is a schematic entire structural view showing a perpendicular magnetic recording reproducing apparatus using the perpendicular magnetic recording medium; and

FIG. 4B is a schematic view showing a magnetic head of the perpendicular magnetic recording reproducing apparatus.

### BEST MODE FOR CARRYING OUT THE INVENTION

In the following paragraphs, some preferred embodiments of the invention will be described by way of example and not limitation. It should be understood based on this disclosure that various other modifications can be made by those in the art based on these illustrated embodiments.

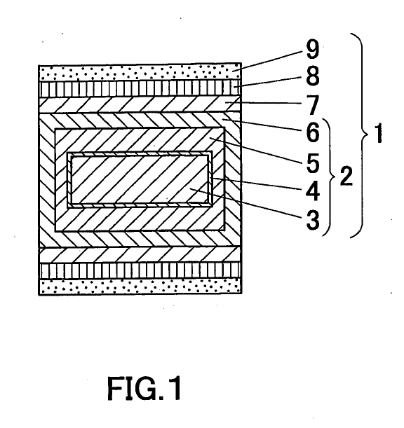

FIG. 1 is a cross-sectional view showing a perpendicular magnetic recording medium according to an embodiment of the present invention.

The perpendicular magnetic recording medium 1 shown in FIG. 1 includes a substrate 2, an orientation controlling coat 7 for controlling the orientation of a coat disposed immediately above, a perpendicular magnetic coat 8 in which an easy axis of magnetization is oriented mainly perpendicular to the substrate 2 and a protective coat 9 laminated this order.

The aforementioned substrate 2 includes a substrate main body 3 made of nonmagnetic material (i.e., nonmagnetic substrate main body), a metal core or a seed coat 4, a soft magnetic substrate coat 5 made of soft magnetic material and an anticorrosion coat 6 for preventing corrosion of the soft magnetic substrate coat 5 laminated in this order.

Hereinafter, the structure of the perpendicular magnetic recording medium 1 according to this embodiment will be explained from the substrate side in order.

In the substrate 2, the substrate main body 3 is not limited to a specific one so long as it is made of nonmagnetic material, and the crystal structure is also not specifically limited so long as it is in the form of single crystal, polycrystal or amorphous. Furthermore, as for the shape of the substrate main body 3 (substrate 2), it can be in any shape, e.g., a disk shape. As the examples, a glass, a silicon wafer and an aluminum disk can be exemplified. Among other things, a glass or an aluminum disk is preferably used. It should be noted that the invention does not preclude that metal compositions such as Sn, Pd or Zn is provided between the substrate main body 3 and the soft magnetic substrate coat 5.

The soft magnetic substrate coat 5 can be formed by, for example, an electroless plating method. However, before forming the soft magnetic substrate coat 5 on the substrate main body 3, it is necessary to form an electroless plating with a surface having catalytic activity on the substrate main body 3 to enhance the forming of the soft magnetic substrate coat 5. The surface having catalytic activity can be formed by, for example, subjecting the substrate main body 3 to a known catalytic processing (Sn/Pd) or forming, e.g., a metal core or a seed coat 4 on the substrate main body 3. Such surface forming method should be appropriately selected depending on the substrate main body 3, but is not limited to a specific method so long as the reaction of the soft magnetic coat of the substrate coat 5 can be initiated evenly.

As the catalytic processing, a conventional one-component or two-component Pd catalytic method and a Pd catalytic method by displacement can be exemplified. Furthermore, before executing the catalytic processing, known pretreatment such as phosphate treatment or acid treatment or ashing treatment by oxygen plasma can be executed. As the metal core, Ni core and Cu core can be exemplified. Such Ni core or Cu core can be formed (given) by, for example, a method for directly making Ni or Cu separate on the substrate main body 3. The aforementioned metal core is preferably nonmagnetic.

On the other hand, in the case of forming the seed coat 4, it is preferable to form the seed coat 4 using metal active in reducing agent contained in the electroless plating bath (plating liquid) for forming the substrate coat 5. Among other things, it is especially preferable to form the seed coat 4 of Ni, Cu or its alloy 5 to 100 nm thick, more preferably 10 to 50 nm thick. In the case of forming the seed coat 4, it is preferable to add Zn in the seed coat 4 to improve the adhesiveness between the substrate main body 3 and the seed coat 4.

As the forming method of the seed coat 4, a drying method such as sputtering or vapor deposition and a wet method such as displacement plating or electroless plating method can be exemplified. Among other things, it is preferable to form the seed coat 4 by an electroless plating, because the seed coat 4 can be formed at low cost and can also be easily formed on the substrate main body 3 so as to entirely cover the substrate main body 3. In the case of forming the seed coat 4 by an electroness deposition method, it is preferable to form the metal core before forming the seed coat 4. In this case, it is preferable to form the metal core by a conventional Pd activation processing. Furthermore, in this case too, before forming the metal core, known pretreatment such as phosphate treatment or acid treatment or ashing treatment by oxygen plasma can be executed.

In the case of forming the seed coat 4, for the purpose of improving the adhesiveness between the substrate main body 3 and the seed coat 4, it is preferable to form an adhesive coat (not shown) of, e.g., Ti or Cr between the substrate main body 3 and the seed coat 4 by a known method such as a sputtering method. In this case, it is preferable that the thickness of the adhesive coat is 5 to 50 nm, more preferably 10 to 30 nm.

Although there will be no problem even if the soft magnetic substrate coat 5 is formed by a sputtering method or an electroless plating method, it is preferable that the soft magnetic substrate coat 5 is formed by an electroless plating method capable of forming the coat at low cost.

As the soft magnetic material constituting the soft magnetic substrate coat 5 formed by an electroless plating method, it is possible to use soft magnetic material at least containing one or more elements selected from the group consisting of Co, Ni and Fe and one or more elements selected from the group consisting of P and B, as composition elements. For example, Co—P, Co—Ni—P, Co—Ni—Fe—P, Co—Ni—B, and Co—Ni—P—B can be exemplified. It is more preferable to use material high in saturation magnetization with Co content of 50 atomic percentage (t) or more or Fe content of 20 atomic percentage (%).

The anticorrosion coat 6 is formed to prevent the corrosion of the soft magnetic substrate coat 5. This anticorrosion coat 6 is preferably made of metallic material having high anticorrosion property (high corrosion resistance characteristic) against the use environment of the perpendicular magnetic recording medium 1. More concretely, the anticorrosion coat 6 is preferably made of metallic material having high corrosion resistance against, e.g., an acid dipping test, a salt water accelerated test (JIS (Japanese Industrial Standard) H8502) or a constant temperature and humidity accelerated test. The metallic material can be metallic alloy or any other material other than alloy.

Among anticorrosion coats made of metallic material, it is preferable that the anticorrosion coat 6 is made of metallic material containing nickel as a base metallic composition. Specifically, the anticorrosion coat 6 is made of metallic material containing nickel and at least one element selected from the group consisting of phosphorus and boron, as composition elements. Such coat can be easily formed by an electroless plating method.

Furthermore, the anticorrosion coat 6 can be nickel alloyed material formed by adding at least one metallic elements selected from the group consisting of gold, tungusten and molybdenum as metal other than nickel to nickel.

Especially, the anticorrosion coat 6 preferably has soft magnetic characteristic, because the forming of such anticorrosion coat 6 on the soft magnetic substrate coat 5 can share the role of the soft magnetic substrate coat 5 to improve the magnetic property of the perpendicular magnetic recording medium 1. As concrete examples of such anticorrosion coat 6, Ni—P, Ni—B, Ni—Au—P, Ni—Au—B, Ni—W—P, Ni—W-B, Ni-MO—P and Ni-Mo-B can be exemplified.

As the composition of the anticorrosion coat 6, in the case of Ni—P, it is preferable that it consists essentially of phosphorus: 1 to 13 atom percentage (hereinafter referred to as “atom %”) (more preferably 1 to 10 atom %) and the balance being nickel.

In the case of Ni—B, it is preferable that it consists essentially of B: 0.01 to 10 atom % (more preferably 0.01 to 5 atom %) and the balance being nickel.

In the case of Ni—Au—P, it is preferable that it consists essentially of Au: 0.1 to 10 atom % (more preferably 0.1 to 5 atom %), P: 1 to 13 atom % (more preferably 1 to 10 atom %) and the balance being nickel.

In the case of Ni—Au—B, it is preferable that it consists essentially of Au: 0.1 to 10 atom % (more preferably 0.1 to 5 atom %), B: 0.01 to 10 atom % (more preferably 0.01 to 5 atom %) and the balance being nickel.

In the case of Ni—W—P, it is preferable that it consists essentially of W: 1 to 20 atom % (more preferably 3 to 15 atom %), P: 1 to 13 atom % (more preferably 1 to 10 atom %) and the balance being nickel.

In the case of Ni—W-B, it is preferable that it consists essentially of W: 1 to 20 atom % (more preferably 3 to 15 atom %), B: 0.01 to 10 atom % (more preferably 0.01 to 5 atom %) and the balance being nickel.

In the case of Ni-MO—P, it is preferable that it consists essentially of Mo: 1 to 20 atom % (more preferably 3 to 15 atom %), P: 1 to 13 atom % (more preferably 1 to 10 atom %) and the balance being nickel.

In the case of Ni-Mo-B, it is preferable that it consists essentially of Mo: 1 to 20 atom % (more preferably 3 to 15 atom %), B: 0.01 to 10 atom % (more preferably 0.01 to 5 atom %) and the balance being nickel.

In the aforementioned composition of the anticorrosion coat 6, the balance can include inevitable impurities. In other words, the balance can be nickel and inevitable impurities.

The aforementioned soft magnetic substrate coat 5 is low in corrosion resistance. Therefore, in a conventional perpendicular magnetic recording medium, corrosion resistance was eventually secured by a protective coat. In general, a protective coat is formed by a dipping method so as to cover the entirety of a soft magnetic substrate coat, an orientation controlling coat and a perpendicular magnetic coat. However, the two layers of the orientation controlling coat and the perpendicular magnetic coat are formed in a laminated manner by a sputtering method. Therefore, at a side surface of a conventional medium, a soft magnetic substrate coat low in corrosion resistance is merely covered by a protective coat. Accordingly, the corrosion resistance of a conventional medium depends on the corrosion resistance of the protective coat. However, as mentioned above, since the main purpose of the protective coat was to prevent damage of the perpendicular magnetic coat caused by contact between the magnetic head and the perpendicular magnetic coat, the protective coat was not enough to secure the corrosion resistance of the soft magnetic substrate coat. Furthermore, since this protective coat was formed as thin as possible so as to decrease the distance between the magnetic head and the perpendicular magnetic coat, it was difficult to secure the corrosion resistance of the soft magnetic substrate coat by the protective coat.

In order to improve the corrosion resistance of the perpendicular magnetic recording medium, it is necessary to improve the corrosion resistance of the soft magnetic substrate coat which is a causal factor of corrosion. In this invention, the anticorrosion coat 6 is formed on the soft magnetic substrate coat 5, preferably formed so as to completely cover the entire soft magnetic substrate coat 5, to solve the aforementioned problems.

For the purpose of solving the above problems, as a method for forming the anticorrosion coat 6, it is preferable to employ not a vapor-phase coat-forming method such as a sputtering method but an electroless plating method because of the following reasons. In vapor-phase processing such as a sputtering method, the external portions or internal portions of the substrate will be fixed with supporting jigs. This may cause incomplete covering of the side surfaces of the substrate 2 (at the stage that the soft magnetic substrate coat 5 is coated) with the anticorrosion coat 6, or may cause corrosion from the side surfaces.

To the contrary, an employment of an electroless plating method as a method of forming the anticorrosion coat 6 enables the anticorrosion coat 6 to completely cover the entirety of the soft magnetic substrate coat 5, preventing occurrence of corrosion from the side surface portions of the substrate 2, which in turn can greatly enhance the corrosion resistance. In addition, such anticorrosion coat 6 can be easily formed. Furthermore, in the electroless plating method, the coating treatment can be easily performed while rotating the substrate 2, enabling the coating of the portions of the substrate 2 supported with jigs, which results in the entire coating of the soft magnetic substrate coat 5. Moreover, by subsequently forming the anticorrosion coat 6 on the soft magnetic substrate coat 5 by an electroless plating method after forming (or immediately after forming) the soft magnetic substrate coat 5, the aforementioned anticorrosion coat 6 can be formed assuredly and efficiently. Accordingly, the corrosion resistance can be assuredly enhanced.

Electroless plating bath (liquid) for forming the anticorrosion coat 6 can be selected from known plating baths depending on the compositions of the anticorrosion coat 6 to be formed.

In this plating bath, as the source of metal ion, water-soluble nickel-salt such as nickel sulfate and nickel chloride can be exemplified. As metal salt (i.e., gold salt, tungsten salt, molybdenum salt) to be added to further enhance the corrosion, similar water-soluble metal salt can be used. The concentration of the metal salt in the plating bath can be arbitrarily set, but is preferably to set such that the total metal salt concentration is 1 to 100 g/litter (0.1 to 10 mass %), more preferably 10 to 50 g/litter (1 to 5 mass %).

In this plating bath, pH buffer such as boric acid can be added. Furthermore, surface active surfactant can be added to improve the uniformity for the coat to be formed by an electroless plating method. As such surface active surfactant, dodecyl sodium sulfate or polyethylene glycol is preferably used. Furthermore, in order to improve the smoothness of the coat, conventional additive agent can be added.

The temperature and the pH of the plating bath at the time of forming the coat can be arbitrarily decided depending on the compositions of the plating bath. It is preferable that the bath temperature is 60 to 90° C. and the pH is 4.5 to 8.5. If the pH is less than 4.5 or exceeds 8.5, the soft magnetic substrate coat 5 may be damaged by the acid component or the alkalis component in the processing liquid since the soft magnetic substrate coat 5 has no corrosion resistance. It is more preferable that the bath temperature is 70 to 85° C. and the bath pH is 7 or therearound. It should be noted that the bath temperature and pH are not limited to the above range in this invention.

Furthermore, the anticorrosion coat 6 formed by the electroless plating method can be subjected to heat treatment to enhance the adhesiveness. In this case, it is preferable that the heat treatment temperature falls within the range of from 150° C. to 300° C.

The thickness of the anticorrosion coat 6 is preferably 1 nm to 5,000 nm, more preferably 20 nm to 3,000 nm. The reasons are as follows. If the thickness of the anticorrosion coat 6 is less than the lower limit, there is a possibility that sufficient anticorrosion effect cannot be obtained. On the other hand, if the thickness of the anticorrosion coat 6 exceeds the upper limit, there are possibilities that the magnetism of the soft magnetic substrate coat 5 is weakened or the productivity deteriorates. However, it should be understood that the thickness of the anticorrosion coat 6 is not limited to the above-identified range.

Furthermore, the average particle diameter of the anticorrosion coat 6 is preferably 20 nm or less, more preferably 10 nm or less. The crystal of the particle is preferably in the form of amorphous. However, it should be noted that the average particle diameter of the anticorrosion coat 6 is not limited to the aforementioned range. Furthermore, it is also not limited that the crystal of the particle is in the form of amorphous.

In this embodiment, the perpendicular magnetic recording medium 1 according to the embodiment of the present invention can be obtained by, e.g., using a substrate 2 in which the entire soft magnetic substrate coat 5 is completely covered with the anticorrosion coat 6, subjecting the substrate 2 to surface polishing (smoothening) by an ordinary method, forming an orientation controlling coat 7, a perpendicular magnetic coat 8 and a protective coat 9. In this perpendicular magnetic recording medium 1, since the substrate 2 according to this embodiment is used, the information recorded in the medium 1 can be held for a long time period in good condition. Hereinafter, an example of a method for manufacturing the perpendicular magnetic recording medium 1 according to the embodiment of the present invention will be explained.

A polishing step (smoothening step) for polishing the surface of the substrate 2 can be performed by, e.g., polishing the surface of the anticorrosion coat 6 after forming it, or by polishing the surface of the soft magnetic substrate coat 5 or seed coat 4 before forming the anticorrosion coat 6. The present invention allows any one of the methods.

It is also acceptable to add a step for eliminating strain of the substrate 2 or the coat by subjecting the entire substrate 2 to heat treatment. In the heat treatment, it is preferable that the temperature is 100 to 350° C., more preferably 150 to 280° C., and that the processing time is 10 to 60 min., more preferably 15 to 45 min. However, the heat treatment temperature and processing time are not limited to the aforementioned ranges.

Concretely, the polishing step (smoothening step) can be preferably performed by a chemical mechanical polishing method using polishing liquid containing polishing agent containing, e.g., alumina or silica (colloidal silica) as main components. As for the surface roughness, the preferable average surface roughness Ra is 2.0 nm to 0.05 nm, more preferably 0.8 nm to 0.05 nm. However, it should be noted that the surface roughness is not limited to the aforementioned range.

The perpendicular magnetic coat 8 can be any magnetic coat with the easy axis of magnetization oriented mainly in the perpendicular direction with respect to the substrate 2 (substrate main body 3), and is not specifically limited in composition. In general, Co series alloy (e.g., CoCrPt, CoCrPtB, CoCrPt—SiO₂, Co/Pd multi layer, CoB/PdB multi layer, CoSiO₂/PdSiO₂ multi layer) or the like can be preferably used.

The perpendicular magnetic coat 8 can be a single layer structure made of the aforementioned Co series alloy material, or can be two or more layer structure including a layer made of Co series alloy material and a layer made of material other than the Co series alloy material.

The perpendicular magnetic coat 8 can have a structure in which a Co series alloy layer and a Pd series alloy layer are laminated, or a multilayered structure containing an amorphous material layer of, e.g., TbFeCo and a CoCrPt series alloy material layer.

The thickness of the perpendicular magnetic coat 8 is preferably set to 3 to 60 nm, more preferably 5 to 40 nm. If the thickness of the perpendicular magnetic coat 8 is less than the range, sufficient magnetic flux cannot be obtained, causing decreased reproduction output. To the contrary, if the thickness of the perpendicular magnetic coat 8 exceeds the upper limit, the magnetic particles in the perpendicular magnetic coat 8 becomes rough, resulting in deteriorated recording reproduction performance.

The coercitivity Hc of the perpendicular magnetic coat 8 is preferably 3,000 Oe or more since a magnetic recording medium with the coercitivity of less than 3,000 Oe is inappropriate for high recording density and poor in thermal fluctuation resistance characteristics. In the aforementioned unit, 1 Oe is about 79 A/m.

The ratio Mr/Ms of the residual magnetization Ms to the saturation magnetization Mr of the perpendicular magnetic coat 8 is preferably 0.9 or more. A magnetic recording medium with the Mr/Ms ratio of less than 0.9 tends to be poor in thermal fluctuation resistance characteristics.

The reverse magnetic domain nucleation magnetic field (−Hn) of the perpendicular magnetic coat 8 is preferably 2,500 Oe or less. A magnetic recording medium with the reverse magnetic domain nucleation magnetic field (−Hn) of less then 0 Oe tends to be poor in thermal fluctuation resistance characteristics.

However, in the present invention, the thickness, coercitivity, Mr/Ms ratio and reverse magnetic domain nucleation magnetic field (−Hn) of the perpendicular magnetic coat 8 are not limited to the aforementioned ranges respectively.

Hereinafter, the reverse magnetic domain nucleation magnetic field (−Hn) will be explained.

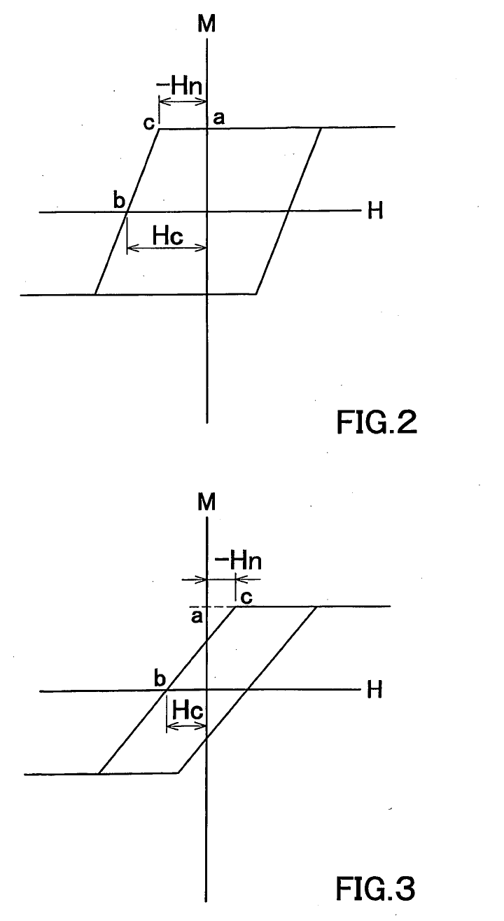

As shown in FIG. 2, in the MH curve, the reverse magnetic domain nucleation magnetic field (−Hn) can be represented by the distance (Oe) between the point a and the point c, wherein the point a is defined as a point where the external magnetic field becomes 0 (zero) in the process of decreasing the external magnetic field from the saturated state of magnetization intensity, the point b is defined as a point where the magnetization intensity becomes 0 (zero) in the aforementioned process, and the point c is defined as a point where the tangent line of the MH curve at the point b and the linear line showing the saturated magnetization are intersected with each other.

The reverse magnetic domain nucleation magnetic field (−Hn) has a positive value when the point c is located in the region where the external magnetic field is negative (see FIG. 2), and has a negative value when the point c is located in the region where the external magnetic field is positive (see FIG. 3).

In the perpendicular magnetic recording medium 1, it is preferable that the orientation controlling coat 7 is made of nonmagnetic material containing Ni: 33 to 80 atom % and further containing at least one metallic element selected from the group consisting of Sc, Y, Ti, Zr, Hf, Nb and Ta. In this case, it becomes possible to secure excellent error rate and thermal fluctuation resistance characteristics. Furthermore, the protective coat 9 can be formed by, e.g., carbon coat (C coat).

It should be noted that the material of the orientation controlling coat 7 and the protective coat 9 are not limited to the above.

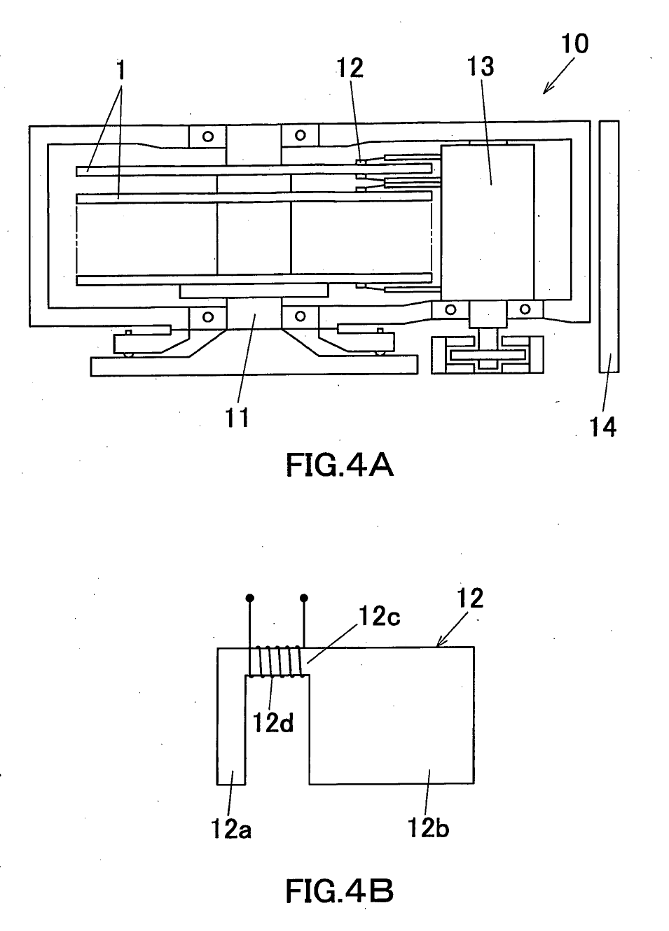

By combining the perpendicular magnetic recording medium 1 according to this embodiment with a known complex type magnetic head, a perpendicular magnetic recording reproducing apparatus can be structured. FIGS. 4A and 4B are schematic views showing a perpendicular magnetic recording reproducing apparatus using the perpendicular magnetic recording medium 1 and a magnetic head used in the apparatus, respectively.

This perpendicular magnetic recording reproducing apparatus 10 is provided with a plurality of plate-shaped perpendicular magnetic recording medium 1 arranged in parallel with each other and a plurality of magnetic heads 12 shown in FIG. 4B each for recording or reproducing the information in or from each medium 1.

In this perpendicular magnetic recording reproducing apparatus 10, the plurality of mediums 1 are rotatably driven concentrically by a medium driving portion 11 made of a spindle. Information is recorded in or reproduced from the perpendicular magnetic coat 8 of the rotating medium 1 with the magnetic head 12 driven by the head driving portion 13. The reference numeral “14” denotes a recording reproducing signal processing portion for recording and reproducing the information in and from the medium 1.

The magnetic head 12 is a complex type magnetic head as shown in FIG. 4B in which a main magnetic pole 12a and an auxiliary pole 12b are connected with each other via a connecting portion 12c. The connecting portion 12c is provided with a coil 12d. It is preferable that this magnetic head 12 can generate writing magnetic field exceeding 3.0 kOe.

With this perpendicular magnetic recording reproducing apparatus 10, information can be recorded in and reproduced from the perpendicular magnetic recording medium 1 assuredly. Furthermore, since this apparatus 10 is provided with the perpendicular magnetic recording mediums 1 according to the embodiment, the information recorded in the perpendicular magnetic recording medium 1 can be retained for a long time period.

### EXAMPLES

The present invention will be detailed with reference to Examples and Comparative Examples, but not limited to them.

### Example 1

As the nonmagnetic substrate main body 3, an Al substrate main body of 2.5 inches diameter was used. The both surfaces of the substrate main body 3 were polished by a conventional method, and then a Ni—P plating coat 12 μm thick as a seed coat 4 was formed on the substrate main body 3 by an electroless plating method. Thereafter, strain of the plating coat was eliminated by performing heat treatment of 250° C.×30 minutes, and then the substrate surface was polished by about 2 μm by performing two-step polishing processing using polishing liquid containing alumina series/silica series polishing agent as a main component to set the average surface roughness Ra of the Ni—P plating coat to 2 nm. Thereafter, a soft magnetic substrate coat 5 of CoNiFeP is formed thereon by a known electroless plating method. Subsequently, an anticorrosion coat 6 of Ni—P with a thickness of 1,500 nm was formed on the soft magnetic substrate coat 5 by an electroless plating method. By this, a Ni—P anticorrosion coat 6 was formed such that it completely covers the entire soft magnetic substrate coat 5. The compositions of the electroless plating bath used to form the anticorrosion coat 6 is shown in Table 1. The bath temperature of this plating bath was set to 85° C. and the pH was set to 6.5. Thereafter, the surface of the Ni—P anticorrosion coat 6 was polished by the two-step polishing processing similar to the aforementioned processing to thereby obtain a substrate 2 in which the entire soft magnetic substrate coat 5 was completely covered by the Ni—P anticorrosion coat 6. The average surface roughness Ra of the surface (i.e., surface to be laminated by the perpendicular magnetic coat 8) of the Ni—P anticorrosion coat 6 of this substrate 2 was measured with the TMS2000 (Texture Measurement System) of Veeco Instruments Inc. The measured result was 0.7 nm. The TEM observation revealed that the average particle diameter of the Ni—P anticorrosion coat 6 was 2 to 5 nm, and the X-ray analysis revealed that the particles were in the form of amorphous. The thickness of the anticorrosion coat 6 after the polishing was 300 nm.

Next, on the anticorrosion coat 6 of the substrate 2 dried under clean environment, as an orientation controlling coat 7, a Co coat 5 nm thick and a Ru coat 5 nm thick were formed in a room temperature by a DC magnetron sputtering method.

Then, on the orientation controlling coat 7, a Co layer 0.2 nm thick and a Pd layer 0.8 nm thick were laminated alternatively to form ten layers, to thereby form a perpendicular magnetic coat 8 (perpendicular magnetic recording coat) with a total thickness of 10 nm.

Furthermore, on the perpendicular magnetic coat 8, a C coat 5 nm thick was formed as a protective coat 9, to thereby obtain a perpendicular magnetic recording medium 1.

As to the obtained perpendicular magnetic recording medium 1, the electromagnetic conversion characteristic was measured using a complex type head provided with a single pole type head for a writing portion and a shield type magnetoresistive head to evaluate the MF-S/N ratio. The results are shown in Table 4.

<Corrosion Resistance Test>

The corrosion resistance tests were performed at two stages, i.e., a step when the perpendicular magnetic recording medium substrate 2 was obtained by forming the anticorrosion coat 6, and a step when the perpendicular magnetic recording medium 1 was obtained by finally forming the protective coat 9. As the tests, constant temperature and constant humidity tests were employed. In the test, the test piece was continuously exposed for two weeks at the temperature of 70 ° C. and humidity of 80%. The results were visually evaluated. The results are shown in Table 4.

### Example 2

In the same manner as in Example 1, a 1,500 nm thick soft magnetic substrate coat 5 of CoNiFeB was formed by a know electroless plating method, except that a glass wafer having a seed coat 4 made of Cu by a sputtering method was used as a substrate in place of the Al substrate with a seed coat of Ni—P. Thereafter, washing and drying were performed, and then heat treatment of 100° C. ×15 minutes was performed. Then, the substrate surface was polished using polishing liquid containing colloidal silica to set the average surface roughness Ra to 0.5 nm. Next, an anticorrosion coat 6 of Ni—Au—P with a thickness of 500 nm was formed on the soft magnetic substrate coat 5 by an electroless plating method. By this, a Ni—Au—P anticorrosion coat 6 was formed such that it completely covers the entire soft magnetic substrate coat 5. The compositions of the electroless plating bath used to form the anticorrosion coat 6 is shown in Table 2. The bath temperature of this plating bath was set to 70° C. and the pH was set to 6.5. The average surface roughness Ra of the surface of the anticorrosion coat 6 was 0.9 nm. Thus, a substrate 2 in which the entire soft magnetic substrate coat was completely covered by a Ni—Au—P anticorrosion coat 6 was obtained. The average particle diameter of the Ni—Au—P anticorrosion coat 6 of this substrate 2 was 10 to 15 nm, and the X-ray analysis revealed that the particles were in the form of amorphous. Hereinafter, in the same manner as in Example 1, a perpendicular magnetic recording medium 1 was measured, and the MF-S/N ratio was measured. The results are shown in Table 4 together with the corrosion resistance test results.

### Example 3

In the same manner as in Example 1, a perpendicular magnetic recording medium 1 was manufactured, except that silicon wafer having a seed coat made of Ni—P was used as a substrate in place of the Al substrate with a seed coat of Ni—P. In the perpendicular magnetic recording medium 1, the compositions of the electroless plating bath used to form the anticorrosion coat 6 and the coat forming conditions were the same as those in Example 1. Hereinafter, a corrosion resistance test was performed in the same manner as in Example 1, and the MF-S/N ratio was measured. The results are shown in Table 4.

### Example 4

In the same manner as in Example 1, a perpendicular magnetic recording medium 1 was manufactured, except that an anticorrosion coat 6 of Ni—B was formed on the soft magnetic substrate coat 5 by an electroless plating method in place of an anticorrosion coat of Ni—P. In this perpendicular magnetic recording medium 1, the compositions of the electroless plating bath used to form the anticorrosion coat 6 are shown in Table 3. The bath temperature of this plating bath was adjusted to 70° C., and the pH was adjusted to 8.0. The average surface roughness Ra of the surface of the Ni—B anticorrosion coat 6 was 0.7 nm, and the coat thickness of the Ni—B anticorrosion coat 6 was 300 nm. A corrosion resistance test was performed in the same manner as in Example 1, and the MF-S/N ratio was measured. The results are shown in Table 4.

### Example 5

In the same manner as in Example 1, a 1,500 nm thick soft magnetic substrate coat 5 of CoNiFeB was formed by a know electroless plating method, except that a glass wafer having a seed coat 4 made of Cu by a sputtering method was used as a substrate in place of the Al substrate with a seed coat of Ni—P. Thereafter, washing and drying were performed, and then heat treatment of 100° C. ×15 minutes was performed. Then, the surface was polished using polishing liquid containing colloidal silica to set the average surface roughness Ra to 0.5 nm. Next, an anticorrosion coat 6 of Ni—Au—P with a thickness of 500 nm was formed on the soft magnetic substrate coat 5 by an electroless plating method. By this, a Ni—Au—P anticorrosion coat 6 was formed such that it completely covers the entire soft magnetic substrate coat 5. The compositions of the electroless plating bath used to form the anticorrosion coat 6 is shown in Table 2. The bath temperature of this plating bath was set to 70 ° C. and the pH was set to 6.5. The average surface roughness Ra of the surface of the anticorrosion coat 6 was 0.9 nm. Thus, a substrate 2 in which the entire soft magnetic substrate coat 5 was completely covered by a Ni—Au—P anticorrosion coat 6 was obtained. The average particle diameter of the Ni—Au—P anticorrosion coat 6 of this substrate 2 was 10 to 15 nm, and the X-ray analysis revealed that the particles were in the form of amorphous. Hereinafter, in the same manner as in Example 1, a perpendicular magnetic recording medium 1 was measured, and the MF-S/N ratio was measured. The results are shown in Table 4 together with the corrosion resistance test results.

### Comparative Example 1

A perpendicular magnetic recording medium 1 was manufactured in the same manner as in Example 1, except that an orientation controlling coat 7 was directly formed on an soft magnetic substrate coat 5 without forming a Ni—P anticorrosion coat 6. Hereinafter, in the same manner as in Example 1, a corrosion resistance test was performed, and the MF-S/N ratio was measured. The results are shown in Table 4. the orientation controlling coat 7 was directly formed on the soft magnetic substrate coat 5 after polishing the surface of the soft magnetic substrate coat 5 to obtain an average surface roughness Ra of 1.0 nm.

In Comparative Example 1, the MF-S/N ratio was better than that of the medium having an anticorrosion coat 6, but the results of the corrosion resistance tests for both the substrate 2 and the perpendicular magnetic recording medium 1 were poor. Since white spots were generated after the tests, it was unable to put into practical use.

### Comparative Example 2

A perpendicular magnetic recording medium 1 was manufactured in the same manner as in Example 1, except that a coat of Co—P was formed on an soft magnetic substrate coat 5 in place of an anticorrosion coat of Ni—P. In this perpendicular magnetic recording medium 1, since the aforementioned Co—P coat does not function as an anticorrosion coat, in the same manner as in Example 1, a corrosion resistance test was performed, and the MF-S/N ratio was measured. The results are shown in Table 4.

In Comparative Example 2, the MF-S/N ratio was better than that of the medium having an anticorrosion coat, but the results of the corrosion resistance tests for both the substrate 2 and the perpendicular magnetic recording medium 1 were poor. Since white spots were generated after the tests, it was unable to put into practical use.

As shown in Table 4, as compared with Comparative Examples, in Examples, the test results of the corrosion resistance tests are good, and it is possible to put into practical use. To the contrary, in Comparative Examples, the MF-S/N ratios are good, but the test results of the corrosion resistance tests are poor. Therefore, it is impossible to stand practical use.

TABLE 1
Plating liquid composition

| | |
|---|---|
| NiSO₄•6H₂O | 39 g/liter |
| NaH₂PO₂•H₂O | 30 g/liter |
| NH₂CH₂COOH | 20 g/liter |
| Na₃C₆H₅O₇•2H₂O | 20 g/liter |
| Bath temperature [° C.] | 85° C. |
| pH | 6.5 |
| pH regulator | NaOH or H₂SO₄ |

TABLE 2
Plating liquid composition

| | |
|---|---|
| NiSO₄•6H₂O | 39 g/liter |
| NaH₂PO₂•H₂O | 30 g/liter |
| NH₂CH₂COOH | 20 g/liter |
| Na₃C₆H₅O₇•2H₂O | 20 g/liter |
| 10% gold colloid (particle | 10 g/liter |
| diameter 10 nm) | |
| Bath temperature [° C.] | 70° C. |
| pH | 6.5 |
| pH regulator | NaOH or H₂SO₄ |

TABLE 3
Plating liquid composition

| | |
|---|---|
| NiCl₂•6H₂O | 30 g/liter |
| CH₂(COOH)₂ | 40 g/liter |
| (CH₃)₂HN•BH₃ | 3.5 g/liter |
| Bath temperature [° C.] | 70° C. |
| pH | 8.0 |
| pH regulator | NH₄OH or HCl |

TABLE 4

| | | Corrosion resistance test results | | |
|---|---|---|---|---|
| | | | Perpendicular | |
| | Composition of | | magnetic | MF-S/N |
| | anticorrosion coat | | recording | ratio |
| | (atm %) | Substrate | medium | [dB] |
| Example 1 | Ni—3P | No change | No change | 12.5 |
| Example 2 | Ni—5Au—3P | No change | No change | 13.4 |
| Example 3 | Ni—3P | No change | No change | 12.5 |
| Example 4 | Ni—1B | No change | No change | 12.7 |
| Com. Ex. 1 | No anticorrosion coat | White spots | White spots | 12.9 |
| Com. Ex. 2 | No anticorrosion coat | White spots | White spots | 14.4 |

### INDUSTRIAL APPLICABILITY

The present invention is applicable to a substrate for a perpendicular magnetic recording medium provided with a recording coat including a magnetic coat in which an easy axis of magnetization is oriented perpendicular to a substrate, its manufacturing method, a perpendicular magnetic recording medium and a perpendicular magnetic record reproducing apparatus equipped with the substrate.

### BROAD SCOPE OF THE PRESENT INVENTION

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

1. A substrate for a perpendicular magnetic recording medium, comprising:
a soft magnetic substrate coat; and
an anticorrosion coat for preventing corrosion of the soft magnetic substrate coat, wherein the anticorrosion coat is formed on the soft magnetic substrate coat.

2. The substrate for a perpendicular magnetic recording medium as recited in claim 1, wherein the anticorrosion coat is formed so as to completely cover the entire soft magnetic substrate coat.

3. The substrate for a perpendicular magnetic recording medium as recited in claim 1, wherein the anticorrosion coat is made of metallic material.

4. The substrate for a perpendicular magnetic recording medium as recited in claim 1, wherein the anticorrosion coat contains nickel and at least one element selected from the group consisting of phosphorus and boron.

5. The substrate for a perpendicular magnetic recording medium as recited in claim 4, wherein the anticorrosion coat contains at least one element selected from the group consisting of gold, tungsten and molybdenum.

6. The substrate for a perpendicular magnetic recording medium as recited in claim 1, wherein the anticorrosion coat is formed by an electroless plating method.

7. The substrate for a perpendicular magnetic recording medium as recited in claim 1, wherein an average particle diameter of the anticorrosion coat is 20 nm or less, and particles of the anticorrosion coat are in an amorphous form.

8. The substrate for a perpendicular magnetic recording medium as recited in claim 1, wherein the thickness of the anticorrosion coat is 1 nm to 5,000 nm.

9. The substrate for a perpendicular magnetic recording medium as recited in claim 1, wherein an average surface roughness Ra of the surface of the anticorrosion coat is 2.0 nm or less.

10. A method for manufacturing a perpendicular magnetic recording medium substrate having a soft magnetic substrate coat, the method comprising the step of:
forming an anticorrosion coat for preventing corrosion of the soft magnetic substrate coat on the soft magnetic substrate coat by an electroless plating method.

11. The method for manufacturing a perpendicular magnetic recording medium substrate as recited in claim 10, further comprising the steps of:
forming a metal core or a seed coat on a substrate main body; and
forming the soft magnetic substrate coat on said metal core or said seed coat by an electroless plating method.

12. The method for manufacturing a perpendicular magnetic recording medium substrate as recited in claim 10, wherein said anticorrosion coat is formed subsequently by the electroless plating method after forming the soft magnetic substrate coat.

13. The method for manufacturing a perpendicular magnetic recording medium substrate as recited in claim 10, wherein the surface of the substrate is polished before or after forming said anticorrosion coat.

14. The method for manufacturing a perpendicular magnetic recording medium substrate as recited in claim 13, wherein the substrate is heat treated at a temperature falling within the range of 100 to 350° C. before polishing the surface of the substrate.

15. A perpendicular magnetic recording medium substrate manufactured by the method for manufacturing a perpendicular magnetic recording medium substrate as recited in claim 10.

16. A perpendicular magnetic recording medium, comprising:
a perpendicular magnetic recording medium substrate as recited in claim 1;
an orientation controlling coat for controlling an orientation of a coat immediately arranged above;
a perpendicular magnetic coat in which an easy axis of magnetization is oriented mainly perpendicular to the substrate; and
a protective coat

17. A perpendicular magnetic recording apparatus, comprising:
a perpendicular magnetic recording medium as recited in claim 16; and
a magnetic head for recording and reproducing information in and from the perpendicular magnetic recording medium.

18. A perpendicular magnetic recording medium, comprising:
a perpendicular magnetic recording medium substrate as recited in claim 15;
an orientation controlling coat for controlling an orientation of a coat immediately arranged above;
a perpendicular magnetic coat in which an easy axis of magnetization is oriented mainly perpendicular to the substrate; and
a protective coat

19. A perpendicular magnetic recording reproducing apparatus, comprising:
a perpendicular magnetic recording medium as recited in claim 18; and
a magnetic head for recording and reproducing information in and from the perpendicular magnetic recording medium.
